(19) United States
(12) Patent Application Publication
(10) Pub. No.: US 2025/0175951 A1
(43) Pub. Date: May 29, 2025

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/730,609

(22) PCT Filed: Jan. 21, 2022
(86) PCT No.: PCT/CN2022/073289

§ 371 Date: Jul. 19, 2024

(51) Int. Cl. H04W 72/0446; H04L 27/26; H04W 72/232

(52) U.S. Cl. CPC H04W 72/0446; H04L 27/2602; H04W 72/232

(57) ABSTRACT

Embodiments of the present disclosure relate to methods, devices, and computer readable medium for communication. According to embodiments of the present disclosure, a network device transmits a slot configuration to a terminal device. The slot format configuration comprises a plurality of configuration parameter sets for a plurality of resource block (RB) sets on a carrier, wherein one configuration parameter set corresponds to one RB set, The network device also transmits downlink control information (DCI) to the terminal device. The terminal device determines a slot format of the plurality of RB sets which is specified to the terminal device based on the DCI. In this way, it provides enhanced uplink coverage and improved configuration flexibility.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. Time domain division (TDD) is widely used in commercial new radio (NR) deployments. In TDD, time domain resources are split between downlink and uplink. Allocation of limited time duration for the uplink in TDD would result in reduced coverage, increased latency and reduced capacity. As a possible enhancement on this limitation of the conventional TDD operation, it would be worth studying the feasibility of allowing the simultaneous existence of downlink and uplink.

### SUMMARY

In general, example embodiments of the present disclosure provide a solution for communication.

In a first aspect, there is provided a method for communication. The communication method comprises: receiving, at a terminal device and from a network device, a slot format configuration comprising a plurality of configuration parameter sets for a plurality of resource block (RB) sets on a carrier, wherein one configuration parameter set corresponds to one RB set; receiving, from the network device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination; determining a first slot format of the plurality of RB sets; and performing a transmission with the network device based on the first slot format.

In a second aspect, there is provided a method for communication. The communication method comprises: transmitting, at a network device and to a terminal device, a slot format configuration comprising a plurality of configuration parameter sets for a plurality of resource block (RB) sets on a carrier, wherein one configuration parameter set corresponds to one RB set; transmitting, to the terminal device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device and from a network device, a slot format configuration comprising a plurality of configuration parameter sets for a plurality of resource block (RB) sets on a carrier, wherein one configuration parameter set corresponds to one RB set; receiving, from the network device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination; determining a first slot format of the plurality of RB sets; and performing a transmission with the network device based on the first slot format.

In a fourth aspect, there is provided a network device. The network device comprises a processing unit; and a memory coupled to the processing unit and storing instructions thereon, the instructions, when executed by the processing unit, causing the network device to perform acts comprising: transmitting, at a network device and to a terminal device, a slot format configuration comprising a plurality of configuration parameter sets for a plurality of resource block (RB) sets on a carrier, wherein one configuration parameter set corresponds to one RB set; transmitting, to the terminal device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a schematic diagram of a slot format according to some embodiments of the present disclosure;

FIG. 4 illustrates a schematic diagram of a slot format according to some embodiments of the present disclosure;

FIG. 5 illustrates a schematic diagram of a slot format according to some embodiments of the present disclosure;

FIG. 6 illustrates a schematic diagram of a slot format according to some embodiments of the present disclosure;

FIG. 7 illustrates a schematic diagram of a slot format according to some embodiments of the present disclosure;

FIG. 8 illustrates a schematic diagram of a slot format according to some embodiments of the present disclosure;

FIG. 9 illustrates a schematic diagram of a slot format according to some embodiments of the present disclosure;

FIG. 10 illustrates a schematic diagram of a slot format according to some embodiments of the present disclosure;

FIG. 11 is a flowchart of an example method in accordance with an embodiment of the present disclosure;

FIG. 12 is a flowchart of an example method in accordance with an embodiment of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Things (IoT) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, it would be worth studying the feasibility of allowing the simultaneous existence of downlink and uplink. For example, duplex enhancements at the network device side can be proposed. In this case, the terminal device is operating in half duplex mode. Different terminal devices need to obtain different slot formats at the same time. However, it is not clear how to implement the subband non-overlapping full duplex operation. Moreover, it is also not clear how to implement potential enhancements on dynamic/flexible TDD.

In order to solve above problems or other potential problems, solutions on duplex operation are proposed. According to embodiments of the present disclosure, a network device transmits a slot configuration to a terminal device. The slot format configuration comprises a plurality of configuration parameter sets for a plurality of resource block (RB) sets on a carrier, wherein one configuration parameter set corresponds to one RB set, The network device also transmits downlink control information to the terminal device. The terminal device determines a slot format of the plurality of RB sets which is specified to the terminal device based on the DCI. In this way, it provides enhanced UL coverage and improved configuration flexibility.

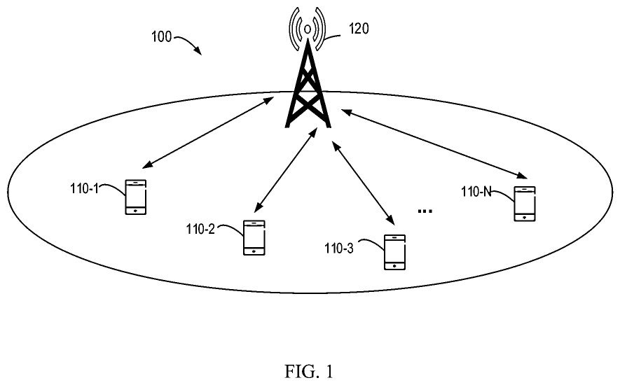

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communicate with each other.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Things (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols. The term “slot format” used herein refers to one slot including downlink symbols, uplink symbols, and flexible symbols.

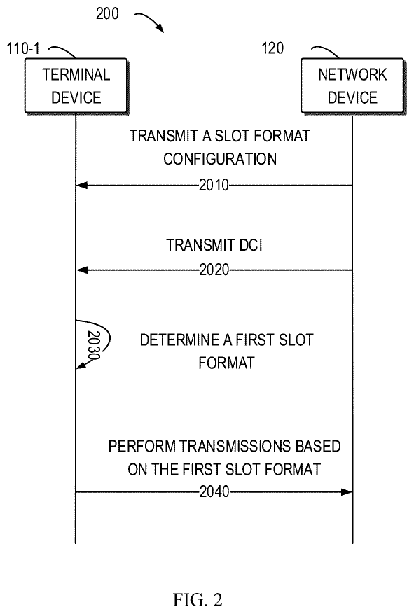

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1.

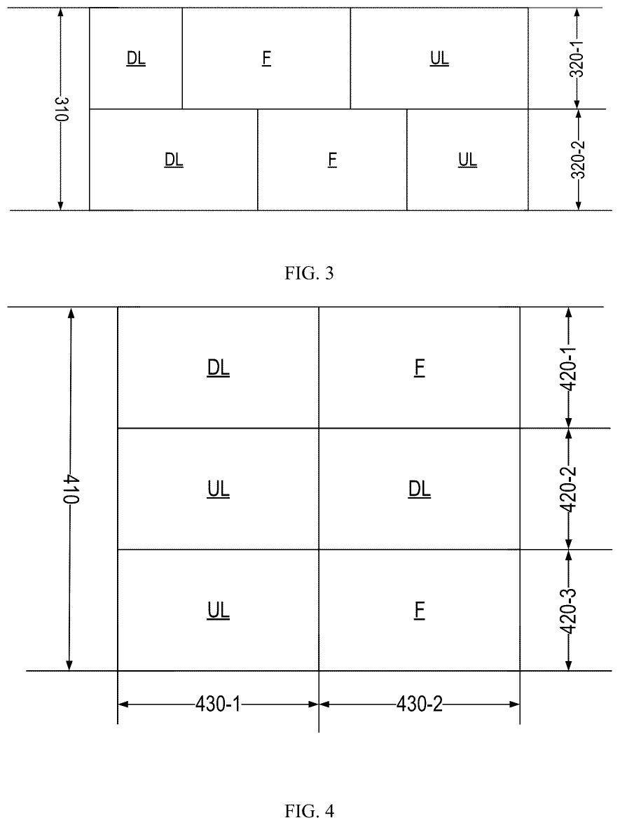

The network device 120 transmits 2010 a slot format configuration to the terminal device 110-1. The slot format configuration comprises a plurality of configuration parameter sets for a plurality of resource block (RB) sets on a carrier. One configuration parameter set corresponds to one RB set. The RB set can comprise a bandwidth part. Alternatively, the RB set can comprise a subband. In other embodiments, the RB set can comprise a number of consecutive physical resource blocks (RB). The RB set may also comprise a number of consecutive resource block groups. Referring to FIG. 3, there may be RB set 320-1 and RB set 320-2 on the carrier 310. The slot format configuration can comprise a configuration parameter set for the RB set 320-1 and a configuration parameter set for the RB set 320-2. It should be noted that the number of RB sets on the carrier 310 shown in FIG. 3 is only an example, and the size of the RB sets can also be different.

In some embodiments, each RB set (for example, the RB set 320-1 and the RB set 320-2) may determine its slot format. For example, the slot format for each RB set can be determined based on the cell-specific configuration in tdd-UL-DL-ConfigurationCommon and UE specific configuration in tdd-UL-DL-ConfigurationDedicated and DCI format 2_0. In this case, the parameter “tdd-UL-DL-ConfigurationCommon” in the information element (IE) ServingCellConfigCommon and the parameter “tdd-UL-DL-ConfigurationDedicated” in the IE ServingCellConfig and the parameter “slotFormatCombToAddModList” in the IE SlotFormatIndicator should be per RB set. Multiple of these parameter sets can be included in these IEs and each parameter set can correspond to one RB set in the serving cell. For example, the parameter set for the RB set 320-1 can comprise parameters “tdd-UL-DL-ConfigurationCommon”, “tdd-UL-DL-ConfigurationDedicated” and the “slotFormatCombToAddModList” which are specific to the RB set 320-1 and the parameter set for the RB set 320-2 can comprise parameters “tdd-UL-DL-ConfigurationCommon”, “tdd-UL-DL-ConfigurationDedicated” and the “slotFormatCombToAddModList” which are specific to the RB set 320-2.

The network device 120 transmits 2020 first DCI to the terminal device 110-1. The first DCI is scrambled by a terminal device specific radio network temporary identity (RNTI) and has a higher priority than a second DCI scrambled by a cell radio network temporary identity (C-RNT) on slot format determination. The terminal device 110-1 determines 2030 a first slot format of the plurality of RB sets which is specified to the terminal device 110-1 based on the first DCI. In this way, it can improve system capacity and configuration flexibility.

In some embodiments, a first part of the plurality of RB sets may be configured as downlink resources, a second part of the plurality of RB sets may be configured as uplink resources, and a third part of the plurality of RB sets may be as flexible resources. In some embodiments, the third part of the plurality of RB sets may be explicitly configured as flexible resources. Alternatively, if the third part of the plurality of RB sets is not configured as downlink resources or uplink resources, the third part of the plurality of RB sets can be considered as flexible resources. For example, referring to FIG. 4, in a time period 430-1, the RB sets 420-2 and 420-3 on the carrier 420 can be semi-static configured as UL resources and the RB set 420-1 on the carrier 420 can be semi-static configured as DL resources. In a time period 430-2, the RB set 420-2 can be semi-static configured as DL resources and the RB sets 420-1 and 420-3 that are not configured can be considered as flexible resources.

In some embodiments, the size of the RB set can be fixed, such as 10 MHz, 20 MHz or 40 MHz. Alternatively, the size of the RB set can be configured by the network device 120. For example, the network device 120 may transmit a system information block (SIB) to the terminal device 110-1. In this case, the SIB can comprise an IE for the RB set. The terminal device 110-1 may determine a subcarrier spacing (SCS) for the RB set based on the IE. Alternatively or in addition, the terminal device 110-1 may determine a frequency position in the carrier for the RB set based on the IE. Alternatively, the terminal device 110-1 may determine a size of the RB set. For example, a new IE can be defined for RB set to determine the SCS for this RB set and the frequency position in the carrier and point A can be the reference start point for each RB set definition. In some embodiments different RB sets may have different numbers of PRBs. Alternatively, the size of the RB set can be directly the same as the configured UL/DL BWP.

In other embodiments, the plurality of RB sets can be flexible resources. The first DCI can comprise a slot format indicator. For example, the first DCI can be scrambled with a slot format indicator radio network temporary identity (SFI-RNTI). The network device 120 may transmit a subband slot format combination list to the terminal device 110-1. In some embodiments, each subband slot format combination in the subband slot format combination list can indicate the slot format for each RB set. In this case, the terminal device 110-1 may determine the first slot format for the plurality of RB sets based on the subband slot format combination list and the slot format indicator in the first DCI. For example, all the resources can be considered as flexible resources, and a subbandslotformatcombinationlist can be defined or configured for the terminal device 110-1. In this case, each subbandslotformatcombination in the subbandslotformatcombinationlist can provide the slot format for each subband (i.e., RB set) for a time duration T. DCI format 2_0 or DCI format i_j may indicate the slot format for each subband in a number of slots for a time duration T. DCI format i_j can be UE-specific. The DCI format 2_0 or DCI format i_j may indicate one of the subbandslotFormatCombinationid. Table 1 below shows mapping between the slot format indicator and the subband slot format combination list. It should be noted that Table 1 is only an example.

TABLE 1

| subbandslotFormatCombinationid | slotFormatforEachSubband |
|---|---|
| 0 | {U, F, D, D, F} |
| 1 | {D, U} |
| 2 | {U, F, F, F, D} |
| 3 | {D, D, F} |

For example, if the higher layer parameter subbandslotformatcombinationlist is configured, the slot format indicator 1 may be used for the subband1 and the slot format indicator 2 may be used for subband 2. Only as an example, if the first DCI comprise the subbandslotFormatCombinationid “2”, the terminal device 110-1 can determine that the slot format can be {U, F, F, F, D}. Here, “U” means UL resource, “D” means DL resource, and “F” means flexible resource.

In some other embodiments, the network device 120 may transmit a second DCI to the terminal device 110-1. The second DCI can indicate a second slot format. The second DCI can be scrambled with a cell RNTI (C-RNTI). In this case, if the second DCI is scrambled by a cell RNTI (C-RNTI), the first slot format may have a higher priority than the second slot format. In some embodiments, the first DCI may override only flexible symbols per slot over the number of slots indicated in a UE-group common DCI, such as DCI format 2_0. In some embodiments, the first DCI may indicate a slot index of a slot, a number of downlink symbols from a first flexible symbol in the slot, and a number of uplink symbols from a last flexible symbol in the slot. For example, the UE-specific SFI indication in the first DCI can indicate the following information:—a slot index for a slot provided by slotIndex; and -nrofDownlinkSymbols provides a number of downlink symbols in the slot from the first flexible symbol and nrofUplinkSymbols provides a number of uplink symbols from the last flexible symbol in the slot. The remaining symbols in the slot are still flexible. Referring to FIG. 6, the flexible symbols per slot over the number of slots as provided by common-DCI can be assigned to the terminal device 110-1 through another UE-specific DCI format x_y. This DCI can be scrambled by a specific RNTI, such as UE-SFI-RNTI, and it overrides only flexible symbols per slot over the number of slots as provided by common-DCI indicated. The priority of the slot format indicated by this DCI is higher than the DCI scrambled by C-RNTI, but lower than DCI 2_0 and tdd-UL-DL-ConfigurationCommon, and tdd-UL-DL-ConfigurationDedicated. Table 2 below shows an example of the priority of the slot format indication.

TABLE 2
For a set of symbols of a slot, a UE does not expect to detect a DCI format
x_y with an UE-SFI-index field value indicating the set of symbols of the
slot as uplink and to detect another DCI format indicating to the UE to
receive PDSCH or CSI-RS in the set of symbols of the slot.
For a set of symbols of a slot, a UE does not expect to detect a DCI format
x_y with an UE-SFI-index field value indicating the set of symbols in the
slot as downlink and to detect another DCI format, a RAR UL grant,
fallbackRAR UL grant, or successRAR indicating to the UE to transmit
PUSCH, PUCCH, PRACH, or SRS in the set of symbols of the slot.
For a set of symbols of a slot that are indicated as downlink/uplink by
tdd-UL-DL-ConfigurationCommon, or tdd-UL-DL-
ConfigurationDedicated or DCI format 2_0, the UE does not expect to
detect a DCI format x_y with an UE-SFI-index indicating the set of
symbols of the slot as uplink/downlink, respectively.

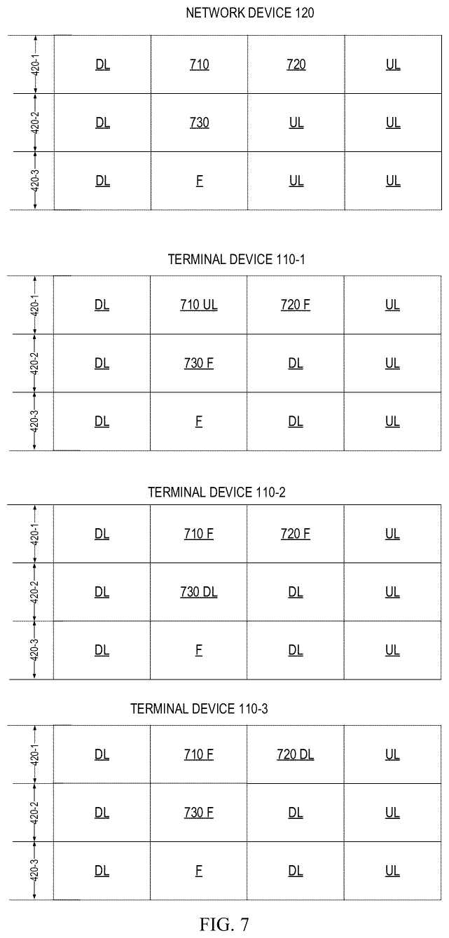

In some embodiments, the first DCI may comprise a slot format indicator. In this case, in some embodiments, the network device 120 may transmit a plurality of common slot format combinations to the terminal device 110-1. The terminal device 110-1 may determine the first slot format for the plurality of RB sets based on the plurality of slot format combinations and the slot format indicator which are specific to the terminal device. For example, the configured slotFormatCombinations may be still the same for terminal devices but the group common slot format indication can be changed to UE-specific slot format indication. In this situation, different terminal devices may be configured with different SlotFormatIndicator or SFI-RNTI, then different terminal devices can determine different slot formats for the flexible symbols after tdd-UL-DL-ConfigurationCommon and/or tdd-UL-DL-ConfigurationDedicated configuration. For example, the slot format indicator can be carried by other UE specific DCI. Such as DCI format e_f can indicate the terminal device 110-1 the slotFormatCombinationid=1, that include the slot formats{3,8,9} and indicate the terminal device 110-1 the slotFormatCombinationid=3, that include the slot formats{6,16,20}, then the terminal device 110-1 can interpret different slot formats. Referring to FIG. 7, the slot formats are different for the terminal devices 110-1, 110-2 and 110-3. For example, the terminal device 110-1 may consider the RB 710 in the RB set 420-1 as UL resources, the terminal devices 110-2 and 110-3 may consider the RB 710 in the RB set 420-1 as flexible resources. In this case, the network device 120 may consider the RB 710 in the RB set 420-1 as UL resources for the terminal device 110-1. The terminal devices 110-1 and 110-2 may consider the RB 720 in the RB set 420-1 as flexible resources and the terminal device 110-3 may consider the RB 720 in the RB set 420-1 as DL resources. In this case, the network device 120 may consider the RB 720 in the RB set 420-1 as DL resources for the terminal device 110-3. The terminal devices 110-1 and 110-3 may consider the RB 730 in the RB set 420-2 as flexible resources and the terminal device 110-2 may consider the RB 730 in the RB set 420-2 as DL resources. In this case, the network device 120 may consider the RB 730 in the RB set 420-2 as DL resources for the terminal device 110-2.

Alternatively, if the first DCI may comprise a slot format indicator, the network device 120 may transmit a plurality of slot format combinations which are specific to the terminal device. In this case, the terminal device 110-1 may determine the first slot format for the plurality of RB sets based on the plurality of slot format combinations and the slot format indicator. This can also reach different UE interpret different slot format even the same index is indicated. For example, the slotFormatCombinations configured to the terminal device 110-1 and terminal device 110-2 can be Table 3 and Table 4. Even the SlotFormatIndicator or SFI-RNTI is the same, such as value=1, but the slot format interpretation can be different. That is to say, if the slot format combination ID is 0, the terminal device 110-1 may determine the slot format combination {1,3,5,6,18,24} based on the slot format combination ID and Table 3 and the he terminal device 110-2 may determine the slot format combination {10,3,5,26,18,24} based on the slot format combination ID and Table 4. For example, even the configuration of SlotFormatIndicator or SFI-RNTI is the same value, but the slot format is different eventually. It should be noted that Table 3 and Table 4 are only examples. The slot format of the slot format index in the table can be from the TS 38.213.

TABLE 3

| SlotFormatCombinationid | SlotFormatCombination |
|---|---|
| 0 | {1, 3, 5, 6, 18, 24} |
| 1 | {2, 3, 4, 16, 38, 44} |
| 2 | {11, 23, 35, 36} |
| 3 | {21, 3, 5, 16, 18} |

TABLE 4

| SlotFormatCombinationid | SlotFormatCombination |
|---|---|
| 0 | {10, 3, 5, 26, 18, 24} |
| 1 | {2, 13, 14, 16, 38, 44} |
| 2 | (21, 23, 35, 26} |
| 3 | (21, 13, 15, 16, 18} |

Each value in the slot format combination may correspond to a type of slot format in the table defined in TS 38.213. For example, the slot format combination {1,3,5,6,18,24} can comprise slot formats of the slot format indexes 1,3,5,6,18, and 24 from the table in TS 38.213.

Referring back to FIG. 2, the terminal device 110-1 performs 2040 a transmission with the network device 120 based on the first slot format. For example, the terminal device 110-1 may perform uplink transmissions on the uplink slots indicated by the first slot format. In this way, the latency for the transmission can be reduced. Moreover, it can achieve improved system capacity.

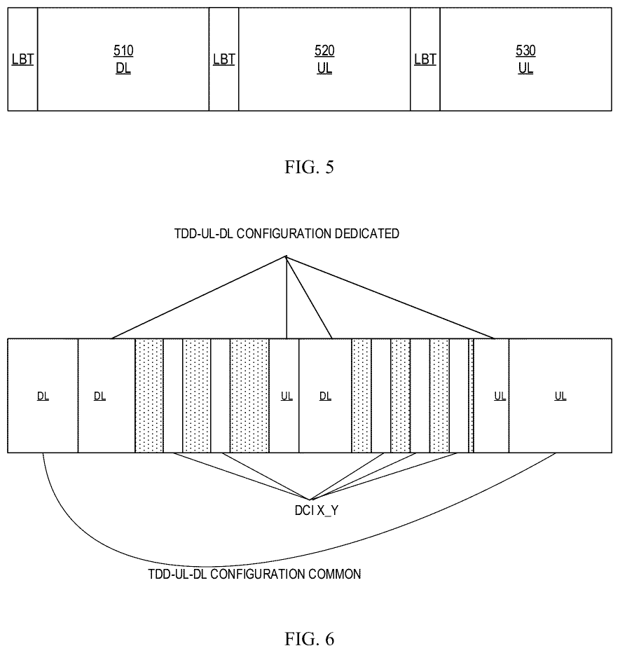

In some embodiments, before performing an uplink transmission on at least one of the plurality of RB sets within a slot, the terminal device 110-1 may perform a listen-before-talk for the slot. In this case, if the listen-before-talk is successful, the terminal device 110-1 may determine this slot as an uplink slot and can transmit the uplink transmission on this slot. The term “listen-before-talk (LBT)” used herein can refer to a technique used in radio communications whereby a radio transmitters first sense its radio environment before it starts a transmission. LBT can be used by a radio device to find a network the device is allowed to operate on or to find a free radio channel to operate on. In some embodiments, the flexible subband (or RB set) can be used for UL or DL transmission. In this case, the flexible subband can be determined for UL or DL transmission based on the LBT result. In some embodiments, the network device 120 can schedule multiple terminal devices at the same time and the LBT can be used for the transmission of one of: physical uplink control channel (PUCCH), physical uplink shared channel (PUSCH), physical downlink shared channel (PDSCH), channel state information reference signal (CSI-RS), or sounding reference signal (SRS). For example, as shown in FIG. 5, in slot 510, the network device 120 can schedule PDSCH1 for the terminal device 110-1, meanwhile the terminal device 110-2 may have configured PUSCH to transmit. In this case, the network device 120 and the terminal device 110-2 may perform the LBT at the same time. If the network device 120 succeeds in the LBT, the network device 120 may transmit the PDSCH to the terminal device 110-1 in the slot 510. In other words, the slot 510 can be the DL slot. Similarly, based on the LBT results, for slot 520, the subband can be used for the UL transmission of the terminal device 110-2, if the terminal device 110-2 succeeds in the LBT. And for slot 530, the subband can be used for UL transmission of the terminal device 110-3, if the other terminal device succeeds in the LBT.

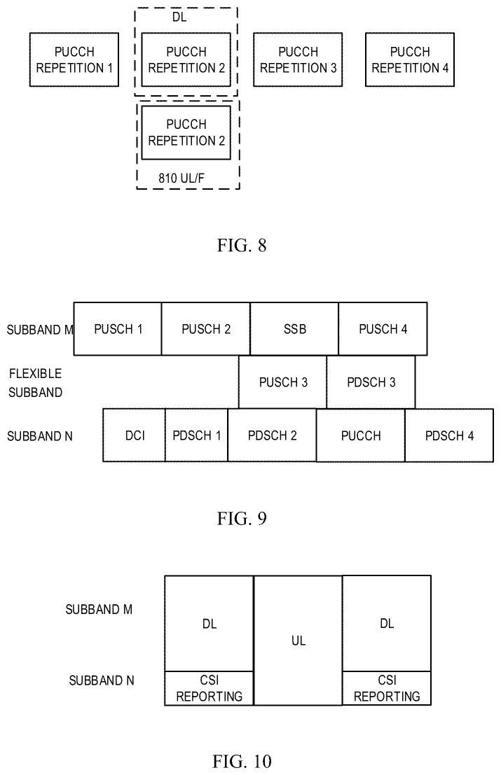

In some embodiments, the slot format configuration indicates flexible RB sets in the plurality of RB sets are reserved for at least one of: a sounding reference signal (SRS), a CSI-RS, a positioning reference signal (PRS), a CSI reporting, a physical uplink control channel (PUCCH), a physical uplink shared channel (PUSCH), a physical random access channel (PRACH), a repetition for PUSCH, or scheduled PUSCH dropped due to unavailable UL resources. For example, referring FIG. 8, if the terminal device 110-1 is configured by higher layers to transmit SRS, or PUCCH, or PUSCH, or PRACH in a set of symbols of a slot and the terminal device 110-1 detects a DCI format 2_0 with a slot format value other than 255 that indicates a slot format with a subset of symbols from the set of symbols as downlink or flexible (that used for transmit data for other UE), the terminal device 110-1 may receive/transmit these channels or signals on the nearest reserved available subband 810 in the set of symbols of the slot. And if there is no available resource, the terminal device 110-1 can delay the PUCCH repetition transmission. Or the DCI scheduling the PUCCH can indicate which scheme is used for the terminal device 110-1.

In some embodiments, the flexible subband can be reserved for PUSCH repetition or multiple scheduled PDSCHs (or PUSCHs) dropped due to unavailable UL resources, and these transmissions can be transferred to the nearest reserved subband. Referring to FIG. 9, if that PUSCH is collided with synchronization signal/physical broadcast channel block (SSB) symbols indicated by ssb-PositionsInBurst or symbol(s) indicated by pdcch-ConfigSIB1 in MIB for a CORESET for Type0-PDCCH CSS set, or if one of multiple PDSCHs (or PUSCHs) scheduled by the DCI collides with UL/DL symbol(s) indicated by tdd-UL-DL-ConfigurationCommon or tdd-UL-DL-ConfigurationDedicated. Then the terminal device 110-1 may receive/transmit the PDSCHs (or PUSCHs) on the nearest reserved subband in the set of symbols of the slot. The frequency domain resource allocation (FDRA) and the modulation coding scheme (MCS) for the transferred PXSCH is the same as indicated in the first DCI scheduling the PXSCH, or can be indicated by the second DCI.

In other embodiments, if the terminal device 110-1 is configured by higher layer to receive configured PDCCH, PDSCH, or CSI-RS and configured by higher layers to transmit SRS, PUCCH, PUSCH, or PRACH, and when tdd-UL-DL-ConfigurationCommon or tdd-UL-DL-ConfigurationDedicated indicates these symbols as uplink or downlink, then the terminal device 110-1 may receive/transmit these channels or signals on the nearest reserved subband in the set of symbols of the slot. Alternatively, if the terminal device 110-1 is configured by higher layers to receive a DL PRS in a set of symbols of a slot and the UE detects a DCI format 2_0 with a slot format value other than 255 that indicates a slot format with a subset of symbols from the set of symbols as uplink, or the terminal device 110-1 detects a DCI format indicating to the terminal device 110-1 to transmit PUSCH, PUCCH, SRS, or PRACH in at least one symbol in the set of the symbols, then the terminal device 110-1 may receive the DL PRS in the set of symbols of the slot on the nearest reserved subband.

In some embodiments, the flexible subband can be reserved for the PUSCH repetition or multiple scheduled PDSCHs (or PUSCHs) dropped due to unavailable UL resources due to unavailable CSI measurement resources or unavailable UL resources. Referring FIG. 10, if CSI reporting is collided with SSB symbols indicated by ssb-PositionsInBurst or symbol(s) indicated by pdcch-ConfigSIB1 in MIB for a CORESET for Type0-PDCCH CSS set on one subband, or if CSI reporting collides with UL/DL symbol(s) indicated by tdd-UL-DL-ConfigurationCommon or tdd-UL-DL-ConfigurationDedicated, the terminal device 110-1 can transmit the CSI reporting on the nearest reserved subband resource in the set of symbols of the slot.

According to embodiments of the present disclosure, different terminal devices can determine different slot formats for the plurality of RB sets on the carrier. In this way, it can achieve enhanced UL coverage. The latency for the transmission can be reduced. Moreover, it can achieve improved system capacity and improved configuration flexibility for NR TDD operations in unpaired spectrum.

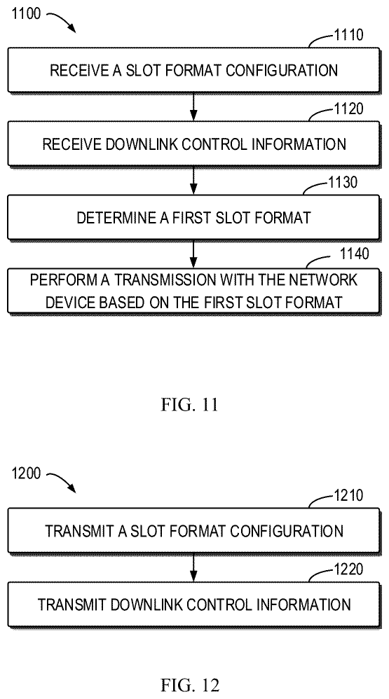

FIG. 11 shows a flowchart of an example method 1100 in accordance with an embodiment of the present disclosure. The method 1100 can be implemented at any suitable devices. Only for the purpose of illustrations, the method 1100 can be implemented at a terminal device 110-1 as shown in FIG. 1.

At block 1110, the terminal device 110-1 receives a slot format configuration from the network device 120. The slot format configuration comprises a plurality of configuration parameter sets for a plurality of resource block (RB) sets on a carrier. One configuration parameter set corresponds to one RB set. The RB set can comprise a bandwidth part. Alternatively, the RB set can comprise a subband. In other embodiments, the RB set can comprise a number of consecutive physical resource blocks (RB). The RB set may also comprise a number of consecutive resource block groups.

In some embodiments, each RB set may determine its slot format. For example, the slot format for each RB set can be determined based on the cell-specific configuration in tdd-UL-DL-ConfigurationCommon and UE specific configuration in tdd-UL-DL-ConfigurationDedicated and DCI format 2_0. In this case, the parameter “tdd-UL-DL-ConfigurationCommon” in the information element (IE) ServingCellConfigCommon and the parameter “tdd-UL-DL-ConfigurationDedicated” in the IE ServingCellConfig and the parameter “slotFormatCombToAddModList” in the IE SlotFormatIndicator should be per RB set. Multiple of these parameter sets can be included in these IEs and each parameter set can correspond to one RB set in the serving cell.

At block 1120, the terminal device 110-1 receives a first DCI from the network device 120. The first DCI is scrambled by a terminal device specific radio network temporary identity (RNTI) and has a higher priority than a second DCI scrambled by a cell radio network temporary identity (C-RNT) on slot format determination.

At block 1130, the terminal device 110-1 determines a first slot format of the plurality of RB sets which is specified to the terminal device 110-1 based on the first DCI. In this way, it can improve system capacity and configuration flexibility.

In some embodiments, a first part of the plurality of RB sets may be configured as downlink resources, a second part of the plurality of RB sets may be configured as uplink resources, and a third part of the plurality of RB sets may be as flexible resources. In some embodiments, the third part of the plurality of RB sets may be explicitly configured as flexible resources. Alternatively, if the third part of the plurality of RB sets is not configured as downlink resources or uplink resources, the third part of the plurality of RB sets can be considered as flexible resources.

In some embodiments, the size of the RB set can be fixed, such as 10 MHz, 20 MHz or 40 MHz. Alternatively, the size of the RB set can be configured by the network device 120. For example, the terminal device 110-1 may transmit a system information block (SIB) from the network device 120. In this case, the SIB can comprise an IE for the RB set. The terminal device 110-1 may determine a subcarrier spacing (SCS) for the RB set based on the IE. Alternatively or in addition, the terminal device 110-1 may determine a frequency position in the carrier for the RB set based on the IE. Alternatively, the terminal device 110-1 may determine a size of the RB set. For example, a new IE can be defined for RB set to determine the SCS for this RB set and the frequency position in the carrier and point A can be the reference start point for each RB set definition. In some embodiments different RB sets may have different numbers of PRBs. Alternatively, the size of the RB set can be directly the same as the configured UL/DL BWP.

In other embodiments, the plurality of RB sets can be flexible resources. The first DCI can comprise a slot format indicator. For example, the first DCI can be scrambled with a slot format indicator radio network temporary identity (SFI-RNTI). The terminal device 110-1 may receive a subband slot format combination list from the network device 120. In some embodiments, each subband slot format combination in the subband slot format combination list can indicate the slot format for each RB set. In this case, the terminal device 110-1 may determine the first slot format for the plurality of RB sets based on the subband slot format combination list and the slot format indicator in the first DCI. For example, all the resources can be considered as flexible resources, and a subbandslotformatcombinationlist can be defined or configured for the terminal device 110-1. In this case, each subbandslotformatcombination in the subbandslotformatcombinationlist can provide the slot format for each subband (i.e., RB set) for a time duration T. DCI format 2_0 or DCI format i_j may indicate the slot format for each subband in a number of slots for a time duration T. The DCI format 2_0 or DCI format i_j may indicate one of the subbandslotFormatCombinationid.

In some other embodiments, the terminal device 110-1 may receive a second DCI from the network device 120. The second DCI can indicate a second slot format. The second DCI can be scrambled with a C-RNTI. In this case, the first slot format may have a higher priority than the second slot format. In some embodiments, the first DCI may override only flexible symbols per slot over the number of slots indicated in a UE-group common DCI, such as DCI format 2_0. In some embodiments, the first DCI may indicate a slot index of a slot, a number of downlink symbols from a first flexible symbol in the slot, and a number of uplink symbols from a last flexible symbol in the slot. For example, the UE-specific SFI indication in the first DCI can indicate the following information: a slot index for a slot provided by slotindex; and nrofDownlinkSymbols provides a number of downlink symbols in the slot from the first flexible symbol and nrofUplinkSymbols provides a number of uplink symbols from the last flexible symbol in the slot. The remaining symbols in the slot are still flexible.

In some embodiments, the first DCI may comprise a slot format indicator. In this case, in some embodiments, the network device 120 may transmit a plurality of common slot format combinations to the terminal device 110-1. The terminal device 110-1 may determine the first slot format for the plurality of RB sets based on the plurality of slot format combinations and the slot format indicator which are specific to the terminal device. For example, the configured slotFormatCombinations may be still the same for terminal devices but the group common slot format indication can be changed to UE-specific slot format indication. In this situation, different terminal devices may be configured with different SlotFormatIndicator or SFI-RNTI, then different terminal devices can determine different slot formats for the flexible symbols after tdd-UL-DL-ConfigurationCommon and/or tdd-UL-DL-ConfigurationDedicated configuration. For example, the slot format indicator can be carried by other UE specific DCI. Such as DCI format e_f can indicate the terminal device 110-1 the slotFormatCombinationid=1, that include the slot formats{3,8,9} and indicate the terminal device 110-1 the slotFormatCombinationid=3, that include the slot formats{6,16,20}, then the terminal device 110-1 can interpret different slot formats.

Alternatively, if the first DCI may comprise a slot format indicator, the network device 120 may transmit a plurality of slot format combinations which are specific to the terminal device. In this case, the terminal device 110-1 may determine the first slot format for the plurality of RB sets based on the plurality of slot format combinations and the slot format indicator. This can also reach different UE interpret different slot format even the same index is indicated. For example, the slotFormatCombinations configured to the terminal device 110-1 and terminal device 110-2 can be Table 3 and Table 4. Even the SlotFormatIndicator or SFI-RNTI is the same, such as value=1, but the slot format interpretation can be different. For example, even the configuration of SlotFormatIndicator or SFI-RNTI is the same value, but the slot format is different eventually.

At block 1140, the terminal device 110-1 performs UL/DL transmissions with the network device based on the first slot format. For example, the terminal device 110-1 may perform uplink transmissions on the uplink slots indicated by the first slot format. In this way, the latency for the transmission can be reduced. Moreover, it can achieve improved system capacity.

In some embodiments, if the terminal device 110-1 needs to perform an uplink transmission on at least one of the plurality of RB sets within a slot, the terminal device 110-1 may perform a listen-before-talk for the slot. In this case, if the listen-before-talk is successful, the terminal device 110-1 may determine this slot as an uplink slot. The term “listen-before-talk (LBT)” used herein can refer to a technique used in radio communications whereby a radio transmitters first sense its radio environment before it starts a transmission. LBT can be used by a radio device to find a network the device is allowed to operate on or to find a free radio channel to operate on. In some embodiments, the flexible subband (or RB set) can be used for UL or DL transmission. In this case, the flexible subband can be determined for UL or DL transmission based on the LBT result. In some embodiments, the network device 120 can schedule multiple terminal devices at the same time and the LBT can be used for the transmission of one of: physical uplink control channel (PUCCH), physical uplink shared channel (PUSCH), physical downlink shared channel (PDSCH), channel state information reference signal (CSI-RS), or sounding reference signal (SRS).

In some embodiments, the slot format configuration indicates flexible RB sets in the plurality of RB sets are reserved for at least one of: a sounding reference signal (SRS), a CSI-RS, a positioning reference signal (PRS), a CSI reporting, a physical uplink control channel (PUCCH), a physical uplink shared channel (PUSCH), a physical random access channel (PRACH), a repetition for PUSCH, or scheduled PUSCH dropped due to unavailable UL resources.

In some embodiments, the flexible subband can be reserved for PUSCH repetition or multiple scheduled PDSCHs (or PUSCHs) dropped due to unavailable UL resources, and these transmissions can be transferred to the nearest reserved subband.

In other embodiments, if the terminal device 110-1 is configured by higher layer to receive configured PDCCH, PDSCH, or CSI-RS and configured by higher layers to transmit SRS, PUCCH, PUSCH, or PRACH, and when tdd-UL-DL-ConfigurationCommon or tdd-UL-DL-ConfigurationDedicated indicates these symbols as uplink or downlink, then the terminal device 110-1 may receive/transmit these channels or signals on the nearest reserved subband in the set of symbols of the slot. Alternatively, if the terminal device 110-1 is configured by higher layers to receive a DL PRS in a set of symbols of a slot and the UE detects a DCI format 2_0 with a slot format value other than 255 that indicates a slot format with a subset of symbols from the set of symbols as uplink, or the terminal device 110-1 detects a DCI format indicating to the terminal device 110-1 to transmit PUSCH, PUCCH, SRS, or PRACH in at least one symbol in the set of the symbols, then the terminal device 110-1 may receive the DL PRS in the set of symbols of the slot on the nearest reserved subband.

In some embodiments, the flexible subband can be reserved for the PUSCH repetition or multiple scheduled PDSCHs (or PUSCHs) dropped due to unavailable UL resources due to unavailable CSI measurement resources or unavailable UL resources.

FIG. 12 shows a flowchart of an example method 1200 in accordance with an embodiment of the present disclosure. The method 1200 can be implemented at any suitable devices. Only for the purpose of illustrations, the method 1200 can be implemented at a network device 120 as shown in FIG. 1.

At block 1210, the network device 120 transmits a slot format configuration to the terminal device 110-1. The slot format configuration comprises a plurality of configuration parameter sets for a plurality of resource block (RB) sets on a carrier. One configuration parameter set corresponds to one RB set. The RB set can comprise a bandwidth part. Alternatively, the RB set can comprise a subband. In other embodiments, the RB set can comprise a number of consecutive physical resource blocks (RB). The RB set may also comprise a number of consecutive resource block groups.

In some embodiments, each RB set (for example, the RB set 320-1 and the RB set 320-2) may determine its slot format. For example, the slot format for each RB set can be determined based on the cell-specific configuration in tdd-UL-DL-ConfigurationCommon and UE specific configuration in tdd-UL-DL-ConfigurationDedicated and DCI format 2_0. In this case, the parameter “tdd-UL-DL-ConfigurationCommon” in the information element (IE) ServingCellConfigCommon and the parameter “tdd-UL-DL-ConfigurationDedicated” in the IE ServingCellConfig and the parameter “slotFormatCombToAddModList” in the IE SlotFormatIndicator should be per RB set. Multiple of these parameter sets can be included in these IEs and each parameter set can correspond to one RB set in the serving cell. For example, the parameter set for the RB set 320-1 can comprise parameters “tdd-UL-DL-ConfigurationCommon”, “tdd-UL-DL-ConfigurationDedicated” and th “slotFormatCombToAddModList” which are specific to the RB set 320-1 and the parameter set for the RB set 320-2 can comprise parameters “tdd-UL-DL-ConfigurationCommon”, “tdd-UL-DL-ConfigurationDedicated” and th “slotFormatCombToAddModList” which are specific to the RB set 320-2.

At block 1220, the network device 120 transmits first DCI to the terminal device 110-1. The first DCI is scrambled by a terminal device specific radio network temporary identity (RNTI) and has a higher priority than a second DCI scrambled by a cell radio network temporary identity (C-RNT) on slot format determination.

In some embodiments, a first part of the plurality of RB sets may be configured as downlink resources, a second part of the plurality of RB sets may be configured as uplink resources, and a third part of the plurality of RB sets may be as flexible resources. In some embodiments, the third part of the plurality of RB sets may be explicitly configured as flexible resources. Alternatively, if the third part of the plurality of RB sets is not configured as downlink resources or uplink resources, the third part of the plurality of RB sets can be considered as flexible resources.

In some embodiments, the size of the RB set can be fixed, such as 10 MHZ, 20 MHz or 40 MHz. Alternatively, the network device 120 can configure the size of the RB set. For example, the network device 120 may transmit a system information block (SIB) to the terminal device 110-1. In this case, the SIB can comprise an IE for the RB set. For example, a new IE can be defined for RB set to determine the SCS for this RB set and the frequency position in the carrier and point A can be the reference start point for each RB set definition. In some embodiments different RB sets may have different numbers of PRBs. Alternatively, the size of the RB set can be directly the same as the configured UL/DL BWP.

In other embodiments, the plurality of RB sets can be flexible resources. The first DCI can comprise a slot format indicator. For example, the first DCI can be scrambled with a slot format indicator radio network temporary identity (SFI-RNTI). The network device 120 may transmit a subband slot format combination list to the terminal device 110-1. In some embodiments, each subband slot format combination in the subband slot format combination list can indicate the slot format for each RB set.

In some embodiments, the network device 120 can schedule multiple terminal devices at the same time and the LBT can be used for the transmission of one of: physical uplink control channel (PUCCH), physical uplink shared channel (PUSCH), physical downlink shared channel (PDSCH), channel state information reference signal (CSI-RS), or sounding reference signal (SRS).

In some other embodiments, the network device 120 may transmit a second DCI to the terminal device 110-1. The second DCI can indicate a second slot format. The second DCI can be scrambled with a C-NTI. In this case, the first slot format may have a higher priority than the second slot format. In some embodiments, the first DCI may override only flexible symbols per slot over the number of slots indicated in a group common DCI, such as DCI format 2_0. In some embodiments, the first DCI may indicate a slot index of a slot, a number of downlink symbols from a first flexible symbol in the slot, and a number of uplink symbols from a last flexible symbol in the slot.

In some embodiments, the first DCI may comprise a slot format indicator. In this case, in some embodiments, the network device 120 may transmit a plurality of common slot format combinations to the terminal device 110-1.

Alternatively, if the first DCI may comprise a slot format indicator, the network device 120 may transmit a plurality of slot format combinations which are specific to the terminal device. In this case, the terminal device 110-1 may determine the first slot format for the plurality of RB sets based on the plurality of slot format combinations and the slot format indicator.

In some embodiments, the slot format configuration indicates flexible RB sets in the plurality of RB sets are reserved for at least one of: a sounding reference signal (SRS), a CSI-RS, a positioning reference signal (PRS), a CSI reporting, a physical uplink control channel (PUCCH), a physical uplink shared channel (PUSCH), a physical random access channel (PRACH), a repetition for PUSCH, or scheduled PUSCH dropped due to unavailable UL resources.

In some embodiments, the flexible subband can be reserved for PUSCH repetition or multiple scheduled PDSCHs (or PUSCHs) dropped due to unavailable UL resources, and these transmissions can be transferred to the nearest reserved subband.

In other embodiments, if the terminal device 110-1 is configured by higher layer to receive configured PDCCH, PDSCH, or CSI-RS and configured by higher layers to transmit SRS, PUCCH, PUSCH, or PRACH, and when tdd-UL-DL-ConfigurationCommon or tdd-UL-DL-ConfigurationDedicated indicates these symbols as uplink or downlink, then the terminal device 110-1 may receive/transmit these channels or signals on the nearest reserved subband in the set of symbols of the slot. Alternatively, if the terminal device 110-1 is configured by higher layers to receive a DL PRS in a set of symbols of a slot and the UE detects a DCI format 2_0 with a slot format value other than 255 that indicates a slot format with a subset of symbols from the set of symbols as uplink, or the terminal device 110-1 detects a DCI format indicating to the terminal device 110-1 to transmit PUSCH, PUCCH, SRS, or PRACH in at least one symbol in the set of the symbols, then the terminal device 110-1 may receive the DL PRS in the set of symbols of the slot on the nearest reserved subband.

In some embodiments, the flexible subband can be reserved for the PUSCH repetition or multiple scheduled PDSCHs (or PUSCHs) dropped due to unavailable UL resources due to unavailable CSI measurement resources or unavailable UL resources.

In some embodiments, a terminal device comprises circuitry configured to: receive, from a network device, a slot format configuration comprising a plurality of configuration parameter sets for a plurality of resource block (RB) sets on a carrier, wherein one configuration parameter set corresponds to one RB set; receive, from the network device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination; determine a first slot format of the plurality of RB sets based on the first DCI; and perform a transmission with the network device based on the first slot format.

In some embodiments, the RB set comprises one of: a bandwidth part, a subband, or a number of consecutive resource blocks, or a number of consecutive resource block groups.

In some embodiments, a first part of the plurality of RB sets is configured as downlink resources, a second part of the plurality of RB sets is configured as uplink resources, and a third part of the plurality of RB sets as flexible resources.

In some embodiments, the terminal device comprises circuitry configured to: receive, from the network device, a system information block (SIB) comprising an information element (IE) for the RB set; and determine, based on the IE, at least one of: a subcarrier spacing (SCS) for the RB set, or a frequency position in the carrier for the RB set, or a size of the RB set.

In some embodiments, the plurality of RB sets are flexible resources, and the first DCI comprises a slot format indicator, and the terminal device comprises circuitry configured to receive, from the network device, a subband slot format combination list; and determine the first slot format for the plurality of RB sets based on the subband slot format combination list and the slot format indicator.

In some embodiments, each subband slot format combination in the subband slot format combination list indicates the slot format for each RB set.

In some embodiments, the terminal device comprises circuitry configured to: perform a listen-before-talk for a slot before the terminal device performs an uplink transmission on at least one of the plurality of RB sets within the slot; and in accordance with a determination that the listen-before-talk is successful, determine the slot as an uplink slot.

In some embodiments, the second DCI scrambled by the C-RNTI indicates a second slot format and the first slot format has a higher priority than the second slot format.

In some embodiments, the first DCI indicates a slot index of a slot, a number of downlink symbols from a first flexible symbol in the slot, and a number of uplink symbols from a last flexible symbol in the slot.

In some embodiments, the first DCI overrides flexible symbols per slot over the number of slots indicated in a UE-group common DCI.

In some embodiments, the first DCI comprises a slot format indicator, and the terminal device comprises circuitry configured to receive, from the network device, a plurality of common slot format combinations; determine the first slot format for the plurality of RB sets based on the plurality of slot format combinations and the slot format indicator.

In some embodiments, the first DCI comprises a slot format indicator, and the terminal device comprises circuitry configured to receive, from the network device, a plurality of slot format combinations which are specific to the terminal device; determine the first slot format for the plurality of RB sets based on the plurality of slot format combinations and the slot format indicator.

In some embodiments, the slot format configuration indicates flexible RB sets in the plurality of RB sets are reserved for at least one of: a sounding reference signal (SRS), a channel state information reference signal (CSI-RS), a positioning reference signal (PRS), a CSI reporting, a physical uplink control channel (PUCCH), a physical uplink shared channel (PUSCH), a physical random access channel (PRACH), a repetition for PUSCH, or scheduled PUSCH dropped due to unavailable UL resources.

In some embodiments, a network device comprises circuitry configured to: transmit, to a terminal device, a slot format configuration comprising a plurality of configuration parameter sets for a plurality of resource block (RB) sets on a carrier, wherein one configuration parameter set corresponds to one RB set; and transmit, to the terminal device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination.

In some embodiments, the RB set comprises one of: a bandwidth part, a subband, or a number of consecutive resource blocks, or a number of consecutive resource block groups.

In some embodiments, a first part of the plurality of RB sets is configured as downlink resources, a second part of the plurality of RB sets is configured as uplink resources, and a third part of the plurality of RB sets as flexible resources.

In some embodiments, the network device comprises circuitry configured to: transmit, to the terminal device, a system information block (SIB) comprising an information element (IE) for the RB set.

In some embodiments, the plurality of RB sets are flexible resources, and the first DCI comprises a slot format indicator, and the network device comprises circuitry configured to transmit, to the terminal device, a subband slot format combination list.

In some embodiments, each subband slot format combination in the subband slot format combination list indicates the slot format for each RB set.

In some embodiments, the second DCI scrambled by the C-RNTI indicates a second slot format and the first slot format has a higher priority than the second slot format.

In some embodiments, the first DCI indicates a slot index of a slot, a number of downlink symbols from a first flexible symbol in the slot, and a number of uplink symbols from a last flexible symbol in the slot.

In some embodiments, the first DCI overrides flexible symbols per slot over the number of slots indicated in a UE-group common DCI.

In some embodiments, the first DCI comprises a slot format indicator, and the network device comprises circuitry configured to transmit, to the terminal device, a plurality of common slot format combinations.

In some embodiments, the first DCI comprises a slot format indicator, and the network device comprises circuitry configured to transmit, to the terminal device, a plurality of slot format combinations which are specific to the terminal device.

In some embodiments, the slot format configuration indicates flexible RB sets in the plurality of RB sets are reserved for at least one of: a sounding reference signal (SRS), a channel state information reference signal (CSI-RS), a positioning reference signal (PRS), a CSI reporting, a physical uplink control channel (PUCCH), a physical uplink shared channel (PUSCH), a physical random access channel (PRACH), a repetition for PUSCH, or scheduled PUSCH dropped due to unavailable UL resources.

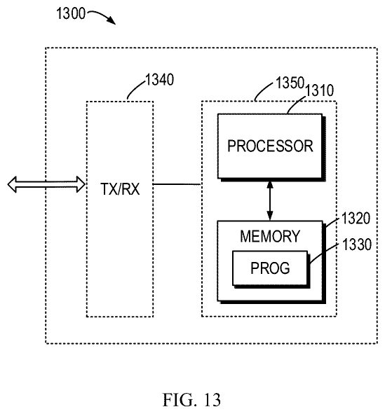

FIG. 13 is a simplified block diagram of a device 1300 that is suitable for implementing embodiments of the present disclosure. The device 1300 can be considered as a further example implementation of the terminal device 110 as shown in FIG. 1. Accordingly, the device 1300 can be implemented at or as at least a part of the terminal device 110. Alternatively, the device 1300 can be considered as a further example implementation of the network device 120 as shown in FIG. 1. Accordingly, the device 1300 can be implemented at or as at least a part of the network device 120.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this application may have several ones.

The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1330 is assumed to include program instructions that, when executed by the associated processor 910, enable the device 1300 to operate in accordance with the embodiments of the present disclosure, as discussed herein with reference to FIGS. 2 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
receiving, at a terminal device and from a network device, a slot format configuration comprising a plurality of configuration parameter sets for a plurality of resource block (RB) sets on a carrier, wherein one configuration parameter set corresponds to one RB set;
receiving, from the network device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination;
determining a first slot format of the plurality of RB sets based on the first DCI; and
performing a transmission with the network device based on the first slot format.

2. The method of claim 1, wherein the RB set comprises one of:
a bandwidth part,
a subband, or
a number of consecutive resource block, or
a number of consecutive resource block groups.

3. The method of claim 1, wherein a first part of the plurality of RB sets is configured as downlink resources, a second part of the plurality of RB sets is configured as uplink resources, and a third part of the plurality of RB sets as flexible resources.

4. The method of claim 1, further comprising:
receiving, from the network device, a system information block (SIB) comprising an information element (IE) for the RB set; and
determining, based on the IE, at least one of:
a subcarrier spacing (SCS) for the RB set, or
a frequency position in the carrier for the RB set, or
a size of the RB set.

5. The method of claim 1, wherein the plurality of RB sets are flexible resources, and the first DCI comprises a slot format indicator, and wherein the method further comprises:
receiving, from the network device, a subband slot format combination list; and
determining the first slot format for the plurality of RB sets based on the subband slot format combination list and the slot format indicator.

6. The method of claim 5, wherein each subband slot format combination in the subband slot format combination list indicates the slot format for each RB set.

7. The method of claim 1, further comprising:
performing a listen-before-talk for a slot before the terminal device performs an uplink transmission on at least one of the plurality of RB sets within the slot; and
in accordance with a determination that the listen-before-talk is successful, determining the slot as an uplink slot.

8. The method of claim 1, wherein the second DCI scrambled by the C-RNTI indicates a second slot format and the first slot format has a higher priority than the second slot format.

9. The method of claim 1, wherein the first DCI indicates a slot index of a slot, a number of downlink symbols from a first flexible symbol in the slot, and a number of uplink symbols from a last flexible symbol in the slot.

10. The method of claim 1, wherein the first DCI overrides flexible symbols per slot over the number of slots indicated in a UE-group common DCI.

11. The method of claim 1, wherein the first DCI comprises a slot format indicator, and wherein the method further comprises:
receiving, from the network device, a plurality of common slot format combinations; and
determining the first slot format for the plurality of RB sets based on the plurality of slot format combinations and the slot format indicator.

12. The method of claim 1, wherein the first DCI comprises a slot format indicator, and wherein the method further comprises:
receiving, from the network device, a plurality of slot format combinations which are specific to the terminal device; and
determining the first slot format for the plurality of RB sets based on the plurality of slot format combinations and the slot format indicator.

13. The method of claim 1, wherein the slot format configuration indicates flexible RB sets in the plurality of RB sets are reserved for at least one of:
a sounding reference signal (SRS),
a channel state information reference signal (CSI-RS),
a positioning reference signal (PRS),
a CSI reporting,
a physical uplink control channel (PUCCH),
a physical uplink shared channel (PUSCH),
a physical random access channel (PRACH),
a repetition for PUSCH, or
scheduled PUSCH dropped due to unavailable UL resources.

14. A communication method, comprising:
transmitting, at a network device and to a terminal device, a slot format configuration comprising a plurality of configuration parameter sets for a plurality of resource block (RB) sets on a carrier, wherein one configuration parameter set corresponds to one RB set; and
transmitting, to the terminal device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination.

15. The method of claim 14, wherein the RB set comprises one of:
a bandwidth part,
a subband, or
a number of consecutive resource block, or
a number of consecutive resource block groups.

16. The method of claim 14, wherein a first part of the plurality of RB sets is configured as downlink resources, a second part of the plurality of RB sets is configured as uplink resources, and a third part of the plurality of RB sets as flexible resources.

17. The method of claim 14, further comprising:
transmitting, to the terminal device, a system information block (SIB) comprising an information element (IE) for the RB set.

18. The method of claim 14, wherein the plurality of RB sets are flexible resources, and the first DCI comprises a slot format indicator, and wherein the method further comprises:
transmitting, to the terminal device, a subband slot format combination list.

19. The method of claim 18, wherein each subband slot format combination in the subband slot format combination list indicates the slot format for each RB set.

20-25. (canceled)

26. A terminal device comprising:
a processor; and
a memory coupled to the processor and storing instructions thereon, the instructions, when executed by the processor, causing the terminal device to;
receive, from a network device, a slot format configuration comprising a plurality of configuration parameter sets for a plurality of resource block (RB) sets on a carrier, wherein one configuration parameter set corresponds to one RB set;
receive, from the network device, first downlink control information (DCI), wherein the first DCI is scrambled by a terminal device specific radio network temporary identity (RNTI) and has a higher priority than a second DCI scrambled by a cell radio network temporary identity (C-RNT) on slot format determination;
determine a first slot format of the plurality of RB sets based on the first DCI; and
perform a transmission with the network device based on the first slot format.

27-28. (canceled)
